(19) United States
(12) Patent Application Publication
(10) Pub. No.: US 2010/0051590 A1
(43) Pub. Date: Mar. 4, 2010

(54) METHOD FOR BUTT JOINT OF ROLLING PIECES

(76) Inventor: Xingyu ZHENG, Beijing (CN)

Correspondence Address: GREENBLUM & BERNSTEIN, P.L.C., 1950 ROLAND CLARKE PLACE, RESTON, VA, 20191, US

(21) Appl. No.: 12/331,463

(22) Filed: Dec. 10, 2008

(30) Foreign Application Priority Data
Sep. 4, 2008 (CN) 200810119653.6

(51) Int. Cl. B23K 11/02

(52) U.S. Cl. 219/104

(57) ABSTRACT

The present invention relates to a method for butt joint of rolling pieces comprising: cutting a head part of a first rolling piece which is in a feeding direction to form a first inclined butt joint edge in a preset sharp angle θ against a working roll generatrix of a working roll, wherein a value of the angle makes the width of the first inclined butt joint edge along a vertical direction of the working roll generatrix greater than the width of a distortion area where the working roll touches the rolling pieces; cutting a tail part of a second rolling piece which is in the feeding direction to form a second butt joint edge parallel to the first inclined butt joint edge; setting the first inclined butt joint edge and the second inclined butt joint edge relatively clingy; and welding relatively clingy parts to connect the first rolling piece with the second rolling piece. The present invention greatly ensures the intensity of the rolling pieces, prevents the rolling piece from being ruptured and ensures the stability of the rolling speed of the whole continuous rolling system and the quality of the rolling pieces.

### CROSS-REFERENCE TO RELATED APPLICATIONS

This application claims priority to Chinese Patent Application No. 200810119653.6, filed on Sep. 4, 2008, entitled “Method for Butt Joint of Rolling Pieces”, which is incorporated herein by reference in its entirety.

### FIELD OF THE TECHNOLOGY

The present invention relates to a method for butt joint of rolling pieces, particularly to a method for butt joint of two rolling pieces butt jointed at head and tail, which belongs to the field of rolling technology.

### BACKGROUND OF THE INVENTION

With development of cold rolling technology and hot rolling technology, large-scale continuous rolling systems are wildly used in large-scale steel manufacturers so that the production efficiency of plate and strip is greatly improved. With characteristics of fast and continuous, a continuous rolling system must be able to be matched with each link in the rolling process of the rolling pieces.

In the prior art, in order to implement continuous rolling, it usually adopts the method of connecting opposite sides of heads and tails by welding. There are two main connection ways as follows:

As shown in FIG. 1, one way is that, at a head-tail joint of two rolling pieces, for a butt joint edge 3 between a latter rolling piece 1 and a former rolling piece 2, a cutter in the continuous rolling system is firstly used to cut the butt joint edge of the rolling piece in a right angle against a long edge of the rolling piece and forms a right-angle butt joint edge to ensure parallelism during the butt joint so as to facilitate welding. After this, the welding is performed at the butt joint edge 3 and then the rolling is performed in the continuous rolling system.

The disadvantage of this way is that welding position has bad tractility and tenacity and is different from the rolling pieces' bodies in terms of stress structure and characteristics. Under the same rolling power, the welding position is easy to be ruptured. When the welding position passes through a working roll generatrix of a rolling mill, the stress structure will be broken. At this time, if the rolling power and speed of the rolling mill do not slow down, the welding position will be ruptured.

Therefore, in the prior art, considering the above disadvantages of weak stress power and weak intensity at the welding position of the butt joint edge between two rolling pieces, it is always solved by adopting methods of decreasing the rolling speed or raising roller slot, which results in frequent adjustment to the speed and the roller slot of each rolling mill. This not only adds the cost of the control system but also greatly influences the quality of the rolling pieces. Particularly, because an electric control system or a hydraulic pressure system has well-known response delay, in practical production, the rolling speed of the whole continuous rolling system can not normally be kept at a steady status.

A Japanese patent document H9-225503 also published another way that, as shown in FIG. 2, at the head-tail juncture of two rolling pieces, for a inclined butt joint edge 6 between the latter rolling piece 1 and the former rolling piece 2, the cutter of the continuous rolling system is firstly used to cut the butt joint edge of the rolling piece in a sharp angle against the long edge of the rolling piece to keep the sharp angle θ between the inclined butt joint edge 6 and the working roll generatrix 4 of a working roll 5 so as to make the inclined butt joint edge 6 become the inclined butt joint edge against the working roll generatrix 4. After this, the welding is performed at the inclined butt joint edge 6 and then the rolling is performed in the continuous rolling system.

By adopting this way to connect the rolling pieces, when the rolling pieces pass through the working roll 5, the welding position will pass through the working roll 5 point by point but not simultaneously. Therefore, this is in favor of assuring the intensity at the welding position of the rolling pieces and there is no need to decrease the speed of the rolling mill. However, when the above method of inclined butt joint edge is adopted to connect the former and latter rolling pieces in the prior art, only the changes of sheet thickness, sheet width and material of the rolling pieces are taken into consideration for choosing the sharp angle θ. In a practical rolling process, the working roll 5 will has a certain distortion after touching the rolling pieces and forms a certain distortion area. If the width of the distortion area becomes greater than the width L2 of the inclined butt joint edge 6, i.e., the welding position of the inclined butt joint edge 6 still passes through the working roll 5 simultaneously but not point by point, which is the same as the first connection way of adopting the right-angle joint. Therefore, it is impossible to ensure the intensity at the welding position of the rolling pieces or achieve expected effect.

### SUMMARY OF THE INVENTION

The object of the present invention is to take the width of the distortion area where the working roll touches the rolling pieces and the radius of the working roll as important factors in selecting the sharp angle formed by the inclined butt joint edge when connecting the former and latter rolling pieces by adopting the method of the inclined butt joint edge, so as to ensure the intensity at the welding position of the rolling pieces.

For this reason, the present invention provides a method for butt joint of rolling pieces comprising the following steps:

Step 1 is to cut a head part of a first rolling piece which is in a feeding direction to form a first inclined butt joint edge in a preset sharp angle θ against a working roll generatrix of a working roll, wherein a value of the angle makes the width of the first inclined butt joint edge along a vertical direction of the working roll generatrix greater than the width of a distortion area where the working roll touches the rolling pieces.

Step 2 is to cut a tail part of a second rolling piece which in the feeding direction to form a second butt joint edge parallel to the first inclined butt joint edge.

Step 3 is to set the first inclined butt joint edge and the second inclined butt joint edge relatively clingy.

Step 4 is to weld relatively clingy parts to connect the first rolling piece with the second rolling piece.

After the present invention adopts the method which performs the welding using the inclined butt joint edges, the welding position will not pass through the working roll simultaneously but pass through the working roll point by point. The welding position of the rolling piece passing through the working roll simultaneously only takes up a small portion of the rolling pieces and most force is imposed on body of the rolling pieces except the welding position, which greatly ensures the intensity of the rolling pieces. At this time, there is no need to decrease the speed of the rolling mill and the rolling pieces will not be ruptured so as to ensure the stability of the rolling speed of the whole continuous rolling system and ensure the quality of the rolling pieces.

The present invention will be described in more detail with reference to the drawings and embodiments.

### BRIEF DESCRIPTION OF THE DRAWINGS

FIG. 1 is a schematic view of adopting a way of a right-angle butt joint edge to implement the butt joint of the rolling pieces in the prior art;

FIG. 2 is a schematic view of adopting a way of a inclined butt joint edge to implement the butt joint of the rolling pieces in the prior art;

FIG. 3 is a structure schematic view of butt joint of rolling pieces in accordance with the present invention;

FIG. 4 is a top view of performing the rolling after adopting the method for butt joint of rolling pieces in accordance with the present invention;

FIG. 5 is a side view of performing the rolling after adopting the method for butt joint of rolling pieces in accordance with the present invention;

FIG. 6 is a flow chart of the method for butt joint of rolling pieces in accordance with the present invention.

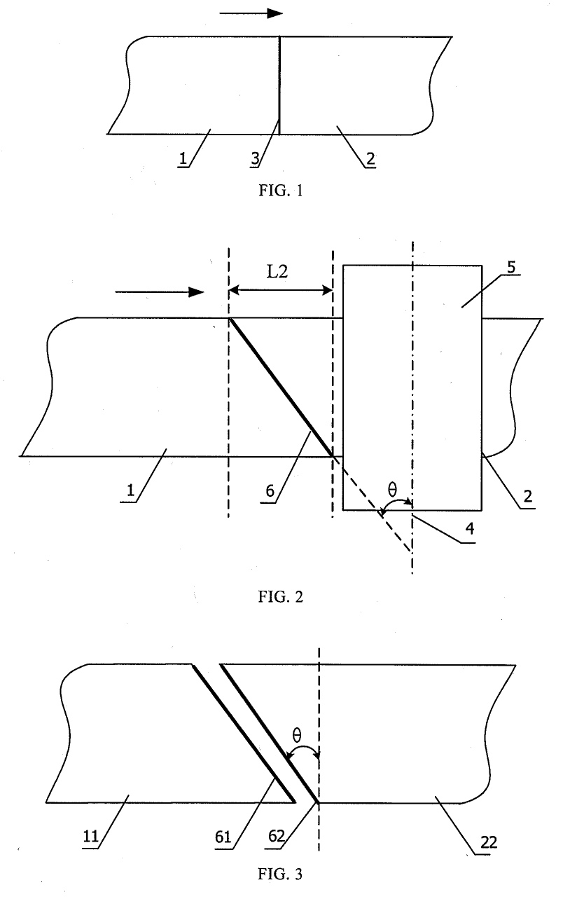

### DESCRIPTION OF FIGURE MARKS

| | | | |
|---|---|---|---|
| 1 | latter rolling piece; | 2 | former rolling piece; |
| 11 | first rolling piece | 22 | second rolling piece |
| 61 | first inclined butt joint edge | 62 | second inclined butt joint edge |
| 4 | working roll generatrix | 5 | working roll |
| 3 | butt joint edge | 6 | inclined butt joint edge |

### DETAILED DESCRIPTION OF THE PREFERRED EMBODIMENTS

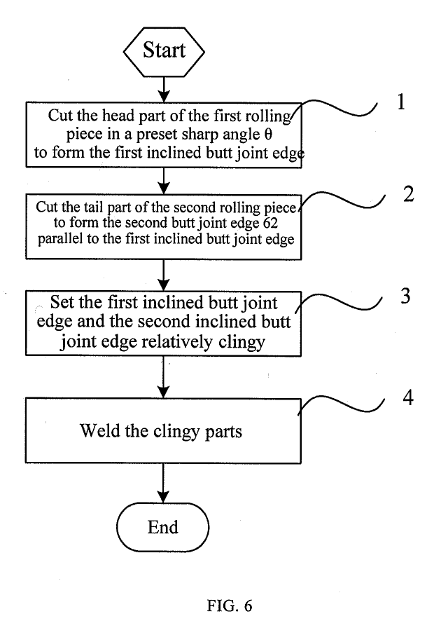

FIG. 3 is a structure schematic view of butt joint of rolling pieces in accordance with the present invention. An arrow direction indicates the feeding direction. FIG. 6 is a flow chart of the method for butt joint of rolling pieces in accordance with the present invention. The method comprises the following steps:

Step 1 is to cut the head part of the first rolling piece 11 which is in the feeding direction to form the first inclined butt joint edge 61 in the preset sharp angle θ against the working roll generatrix 4.

The sharp angle θ is determined by the width of the distortion area where the working roll 5 touches the rolling piece and the width of the first inclined butt joint edge 61 along the vertical direction of the working roll generatrix 4. Specifically, in order to implement the object of the present invention, i.e., in order to ensure the intensity at the welding position of rolling pieces, the value of the angle should be able to make the width of the first inclined butt joint edge 61 along the vertical direction of the working roll generatrix 4 greater than the width of the distortion area where the working roll 5 touches the rolling pieces.

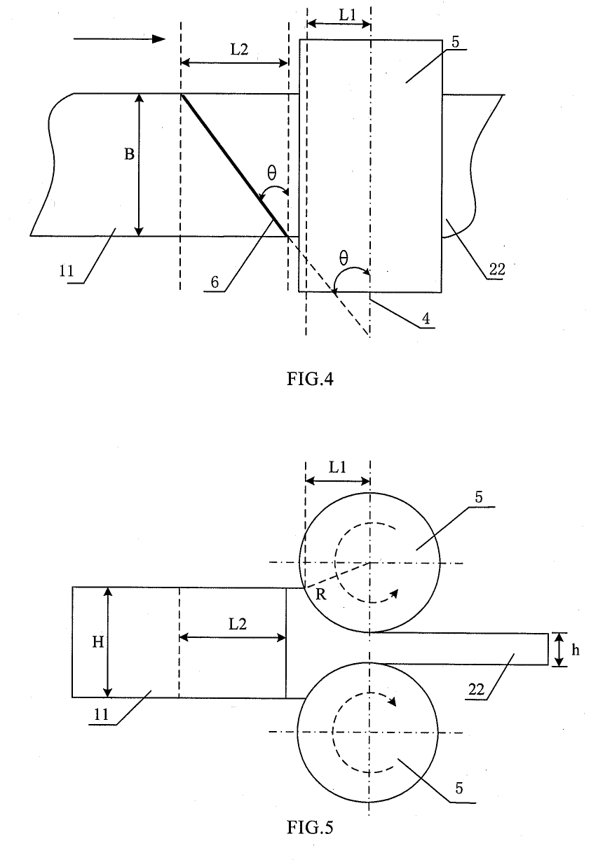

As shown in FIG. 4 and 5, they are respectively the top view and side view of performing the rolling after adopting the method for butt joint of rolling pieces in accordance with the present invention, in which L1 indicates the width of the distortion area where the working roll 5 touches the rolling pieces and L2 indicates the width of the first inclined butt joint edge 61 along the vertical direction of the working roll generatrix 4. We all know L1=\sqrt{R·Δh}, where R indicates the radius of the working roll 5; Δh=H−h, where H indicates the thickness of the rolling pieces before passing through the working roll 5, h indicates the thickness of the rolling pieces after passing through the working roll 5. After being rolled by the working roll 5, the rolling pieces have a thickness difference Δh, i.e., press-down quantity.

In order to implement the object of the present invention, i.e., in order to ensure the intensity at the welding position of the rolling pieces, the L2 should be greater than the L1. Based on trigonometric formulas, it can be deducted that the above angle θ should meet the following relation:

$$L 2 > L 1 \frac{B}{cot θ} > \sqrt{R Δ h} θ > arc cot ( \frac{B}{\sqrt{R ( H - h )}} )$$

where B indicates the width of the connected rolling pieces. The width of the first rolling piece 11 is normally the same as the width of the second rolling piece 22, and the width will not be changed after being connected.

Step 2 is to cut the tail part of the second rolling piece 22 which is in the feeding direction to form the second butt joint edge 62 parallel to the first inclined butt joint edge 61.

Step 3 is to set the first inclined butt joint edge 61 and the second inclined butt joint edge 62 relatively clingy.

As a matter of fact, the first inclined butt joint edge 61 and the second inclined butt joint edge 62 are superposed. Therefore, after being set clingy, the first inclined butt joint edge 61 and the second inclined butt joint edge 62 can be represented as inclined butt joint edge 6 together.

Step 4 is to weld the relatively clingy parts so as to connect the first rolling piece 11 with the second rolling piece 22.

The sharp angle θ formed by the inclined butt joint edge and the working roll generatrix 4 of the rolling mill is selected according to the width of the distortion area where the working roll touches the rolling pieces. When the rolling pieces pass through the working roll 5, because the width L1 of the distortion area where the working roll 5 touches the rolling pieces is always less than the width L2 of the inclined butt joint edge 6 along the vertical direction of the working roll generatrix 4, the welding position will not pass through the working roll simultaneously but passes through the working roll point by point. The welding position of the rolling pieces passing through the working roll simultaneously only takes up a small portion of the rolling pieces and most force is imposed on the body of the rolling pieces except the welding position, which greatly ensures the intensity of the rolling pieces. At this time, there is no need to decrease the speed of the rolling mill or adjust the roller slot. The rolling pieces will not be ruptured so as to ensure the stability of the rolling speed of the whole continuous rolling system and ensure the quality of the rolling pieces.

In addition, in order to further decrease the proportion taken up by the welding position of rolling pieces passing through the working roll simultaneously, the L2 may be three times greater than the L1. Based on the trigonometric formulas, it can be deducted that the above angle θ should meet the following relation:

$$L 2 > 3 L 1 \frac{B}{cot θ} > 3 \sqrt{R Δ h} θ > arc cot ( \frac{B}{3 \sqrt{R ( H - h )}} )$$

By further increasing the difference between L2 and the, the proportion taken by the welding position in the rolling pieces passing through the working roll simultaneously will become less so as to further decrease the force imposed on the welding position and ensure the intensity of the rolling pieces better.

In the above technical solutions, it can include a step 5 after the step 4. The step 5 is to polish the welding position, which is in favor of improving surface smoothness of the rolling pieces so as to raise the speed of the rolling process.

Finally, it should be understood that the above embodiments are only used to explain, but not to limit the technical solution of the present invention. In despite of the detailed description of the present invention with referring to above preferred embodiments, it should be understood that various modifications, changes or equivalent replacements can be made by those skilled in the art without departing from the spirit and scope of the present invention and covered in the claims of the present invention.

What is claimed is:

1. A method for butt joint of rolling pieces, comprising:
step 1, cutting a head part of a first rolling piece which is in a feeding direction to form a first inclined butt joint edge in a preset sharp angle θ against a working roll generatrix of a working roll, wherein a value of the angle makes the width of the first inclined butt joint edge along a vertical direction of the working roll generatrix greater than the width of a distortion area where the working roll touches the rolling pieces;
step 2, cutting a tail part of a second rolling piece which is in the feeding direction to form a second butt joint edge parallel to the first inclined butt joint edge;
step 3, setting the first inclined butt joint edge and the second inclined butt joint edge relatively clingy; and
step 4, welding relatively clingy parts to connect the first rolling piece with the second rolling piece.

2. The method according to claim 1, wherein the angle meets the following relation:
$$θ > arc cot ( \frac{B}{\sqrt{R ( H - h )}} )$$
where θ indicates the value of the sharp angle, B indicates the width of the connected rolling pieces, H indicates the thickness of the connected rolling pieces before passing through the working roll, h indicates the thickness of the connected rolling pieces after passing through the working roll and R indicates the radius of the working roll.

3. The method according to claim 1, wherein the value of the angle makes the width of the first inclined butt joint edge along the vertical direction of the working roll generatrix three times greater than the width of the distortion area where the working roll touches the rolling pieces.

4. The method according to claim 3, wherein the angle meets the following relation:
$$θ > arc cot ( \frac{B}{3 \sqrt{R ( H - h )}} )$$
where θ indicates the value of the sharp angle, B indicates the width of the connected rolling pieces, H indicates the thickness of the connected rolling pieces before passing through the working roll, h indicates the thickness of the connected rolling pieces after passing through the working roll and R indicates the radius of the working roll.
